(19) United States
(12) Patent Application Publication
(10) Pub. No.: US 2025/0377630 A1
(43) Pub. Date: Dec. 11, 2025

(54) LAMINATED PANE WITH HOLOGRAM ELEMENT

(71) Applicant: SAINT-GOBAIN GLASS FRANCE, COURBEVOIE (FR)

(72) Inventors: Oliver GIER, HERZOGENRATH (DE); Andreas GOMER, HERZOGENRATH (DE); Jan HAGEN, HERZOGENRATH (DE)

(21) Appl. No.: 18/876,507

(22) PCT Filed: Jun. 13, 2023
(86) PCT No.: PCT/EP2023/065785

§ 371 Date: Dec. 18, 2024

(30) Foreign Application Priority Data
Jun. 21, 2022 (EP) 22180033.7

(51) Int. Cl. G03H 1/02; B32B 17/10; G02B 5/20; G02B 27/01

(52) U.S. Cl. CPC G03H 1/0256; B32B 17/10045; G02B 5/208; G02B 27/0103; B32B 2307/71; B32B 2605/10; B32B 2605/12; B32B 2605/18; G02B 2027/0194; G03H 2250/33; G03H 2250/35; G03H 2250/42

(57) ABSTRACT

A laminated pane includes an outer pane having an outer surface and an interior surface, an inner pane having an outer surface and an interior surface, a first intermediate layer, and a hologram element having at least one hologram, wherein the first intermediate layer is arranged between the outer pane and the inner pane, the hologram element is arranged between the outer pane and the first intermediate layer or between the inner pane and the first intermediate layer, and wherein a UV protection layer is arranged on the interior surface of the outer pane.

The invention relates to a laminated pane with a hologram element and a UV protection coating, to a method for producing such a laminated pane, and to the use thereof.

Laminated panes are nowadays used in many places, and in particular in vehicle construction. In this context, the term, “vehicle,” includes road vehicles, aircraft, ships, agricultural machinery, or even work equipment.

Laminated panes are also used in other areas. These include, for example, building glazing or information displays, e.g., in museums or as advertising displays.

Laminated panes are frequently also used as head-up displays (HUD) to display information. In this case, an image is projected onto the laminated glass panes by means of an imaging unit in order to display information in the viewer's field of view. In the vehicle sector, the imaging unit is arranged, for example, on the dashboard, such that the projected image is reflected in the direction of the viewer on the nearest glass surface of the laminated glass pane that is inclined towards the viewer (cf., for example, European patent EP 0 420 228 B1 or German patent application DE 10 2012 211 729 A1).

Head-up displays in which the projected image is reflected in the direction of the viewer on the nearest glass surface of the laminated glass pane that is inclined towards the viewer are subject to the law of reflection, according to which the angle of incidence and the angle of reflection are equal. The angle of inclination of the laminated glass pane cannot thus be freely selected.

Hologram elements laminated between the panes of a laminated pane can also be used for head-up displays. The hologram element has at least one hologram, and the hologram can contain information recorded therein. The hologram can be activated by means of light emitted by a projector and the information recorded in the hologram can thus be reproduced for the viewer. Head-up displays based on the principle of holography, so-called holographic head-up displays, are disclosed, for example, in publications WO 2012/156124 A1, US 2019/0056596 A1, U.S. Pat. Nos. 10,394,032 B2, 10,061,069 B2, and US 2015/205138 A1.

DE 10 2020 112 447 A1 discloses a method for integrating a hologram into a rigid component of a predetermined surface target geometry using a hologram-receiving layer of a liquid photopolymer.

A hologram can be produced in a holographic material, i.e., a photosensitive material, which is laminated between the panes of a laminated pane. To record a hologram, two, mutually-coherent light beams—the so-called reference beam—which can also be referred to as a reference wave, and the so-called object beam, which can also be referred to as an object wave, are directed onto a holographic material. The resulting interference pattern of the superimposed wave fronts is written to the holographic material as an alternating refractive index modulation. If the reference wave and the object wave have parallel wavefronts, the interference pattern corresponds to a parallel grating whose lamellae are angled below the angle bisector of reference wave and object wave. After recording, the holographic material is cured, thereby losing the ability to record further holograms. If the holographic material in which the hologram was recorded is again irradiated with the reference wave, the light at the recorded grating of the hologram is diffracted such that the diffracted wave corresponds to the object wave. By illuminating the interference pattern written into the holographic material with the reference wave, the object wave can thus be reconstructed.

Head-up displays in which the projected image is reproduced by means of a hologram in the direction of the viewer thus make it possible to produce laminated panes with laminated holograms, in which the angle of incidence on the laminated pane is not as large as the angle of reflection. Consequently, the angle of inclination of the laminated pane can be selected more freely for holographic head-up displays.

It is advantageous when producing a laminated pane with a hologram to record the hologram in the holographic material of a hologram element precursor only after the lamination process, since the lamination process can have a negative effect upon the optical properties of a recorded hologram. A method for producing a laminated holographic display in which the hologram is recorded only after lamination is disclosed, for example, in EP 3 461 636 B1.

However, recording a hologram in the holographic material of a hologram element precursor laminated between two glass panes is problematic, because any change in the refractive index causes reflections of the object beam and the reference beam when the hologram is being recorded. Thus, undesirable reflections on the surfaces of the two glass panes facing away from the holographic material lead to undesirable interference patterns, and thus to undesirable gratings recorded in the holographic material. These undesirable, recorded gratings result in the hologram showing undesirable artifacts when irradiated with the reference wave after the holographic material has cured. In addition, the undesirable gratings recorded in the hologram can be activated from the outside by external light sources. This leads to unnecessary distractions and possibly glare for the viewer, and should therefore be minimized for safety reasons.

In the context of the present application, the term, “hologram element precursor,” means the precursor of a hologram element. A hologram element precursor does not have a hologram. By recording at least one hologram by exposing the holographic material of a hologram element precursor to an object beam and a reference beam, a hologram element is obtained. The hologram element obtained differs from the hologram element precursor in that at least one hologram is recorded in the hologram element.

In WO 2021/087286 A1, a replication tool for use in producing a holographic film by replication is disclosed, and a method for producing laminated glazing using the replication tool is disclosed. During replication, an oil or gel having a matching refractive index may be arranged in a cavity between the laminated glazing and the main holographic film arrangement to reduce reflections during replication and improve the quality of the laminated glazing.

Whereas, in head-up displays in which the projected image is reproduced by means of a hologram in the direction of the viewer, a reflection of the reference wave on the outer surface of the outer pane is attenuated as a result of diffraction at the recorded grating of the hologram; in particular, a reflection of the reference wave on the interior surface of the inner pane can appear as a weak but nevertheless interfering ghost image. If the light emitted by a projector and incident upon the laminated pane at the Brewster (incidence) angle is exclusively p-polarized, the reflected portion of the light at the Brewster angle is close to zero.

Holographic materials for holographic HUD applications, for example for windshields in vehicles, can be photosensitive polymers (PP) or gels. Such photosensitive materials are commercially available. It is known that incident light, in particular in the ultraviolet spectrum, can significantly influence the physical properties of such photosensitive materials of holographic films over time. The typical service life and durability of windshields is approximately 7 to 12 years, in the area of trucks 2 to 4 years. The aging effects that are observed within such time periods relate, inter alia, to the change in color (discolorations), the mechanical and physical properties, the size and even the holographic properties of these films.

WO 2021/091818 A1 discloses a laminated glass pane which provides for an intermediate layer with UV-absorbing particles for protecting the holographic medium from UV light between the outer pane and the holographic medium. A second intermediate layer remains without UV-light-absorbing particles in order to enable the UV curing of the photosensitive polymer. After the completed curing and lamination to form the laminated pane, a UV-light-absorbing coating is applied to the inner side of the inner pane (side IV).

WO 2021/219285 A1 describes a vehicle pane comprising an electroluminescent device and an optical band-blocking filter, wherein the electroluminescent device emits light and the optical band-blocking filter significantly reduces the radiation of the electroluminescent device in one emission direction. In this way, the emission of light in an undesired emission direction is prevented. The band-blocking filter is designed as a thin-film coating comprising optically high-refractive layers having a refractive index greater than 1.8 and optically low-refractive layers having a refractive index of less than 1.8.

WO 2021/041635 A1 discloses a method for producing a glazing, wherein a first glass pane, a first intermediate layer, a photopolymer film, a second intermediate layer and a second glass pane are laminated together and the photopolymer film is subsequently exposed. Optionally, the glazing comprises an infrared-reflecting layer which, in turn, may optionally be at least partially reflective even within other wavelength ranges, such as in the ultraviolet range.

US 2022/0176682 A1 discloses an intermediate layer for laminated panes, which comprises a hologram element and a first thermoplastic intermediate layer, wherein the first thermoplastic intermediate layer contains a UV absorber.

The object of the present invention is to provide, in particular for a head-up display, an improved laminated pane with a hologram element, in which pane the hologram element in particular can have improved durability and service life. In particular, aging processes, such as the deterioration properties, in particular the holographic properties, or a color changes in the visible spectrum are to be avoided or at least significantly delayed. In addition, the laminated pane with the holographic HUD is to be simple and inexpensive to produce, even in industrial series production.

The object of the present invention is achieved by a laminated pane according to independent claim 1. Preferred embodiments are apparent from the dependent claims. A method for producing a laminated pane according to the invention and the use thereof are apparent from further independent claims.

The invention relates to a laminated pane at least comprising an outer pane having an outer surface and an interior surface, an inner pane having an outer surface and an interior surface, a first intermediate layer, and a hologram element having at least one hologram.

The first intermediate layer is arranged between the outer pane and the inner pane, and the hologram element is arranged between the outer pane and the first intermediate layer or between the inner pane and the first intermediate layer.

According to the invention, a UV protection layer is applied to the interior surface of the outer pane (side II) at least in the region of the hologram element. In the region of the hologram element, this means that a projection of the hologram element into the plane of the UV protection layer overlaps the latter in terms of area. In a view through the laminated pane, the UV protection layer thus lies between the outer pane and the hologram element so that the UV radiation impinging through the outer pane on the hologram element first passes through the UV protection layer. The UV protection layer is also referred to as UV protection coating, i.e., is applied in the form of a coating directly to the interior surface (side II) of the outer pane. The UV protection layer applied to the side II of the outer pane can thus advantageously prevent or at least largely avoid aging processes and changes in the material properties of the hologram element caused by UV radiation in sunlight from the outside, or can delay them beyond the typical lifetime of the laminated pane. In particular, changes in the photosensitive material by the incident sunlight, and in particular the UV light component, and associated change and deterioration of the holograms recorded in the holographic material can be effectively prevented or at least largely avoided. As a result, the durability of the laminated pane with a constant quality of the holographic HUD function can advantageously be significantly prolonged.

The outer pane, also referred to as the first pane, constitutes a pane of the laminated pane that is adjacent to the outside environment in the installed state of the laminated pane. The outer pane has an exterior surface, also referred to as side I, facing towards and adjacent to the vehicle surroundings. The pane surface of the outer pane opposite the outer surface of the outer pane is referred to as the interior surface, also called side II, of the outer pane and, in the installed state of the glazing, faces toward the interior. The inner pane, also referred to as the second pane, constitutes the pane of the laminated pane that faces the interior in the state installed in a vehicle. The inner pane has an outer surface, also referred to as side III, which faces toward the outer pane and the environment in the installed state. The pane surface of the inner pane opposite the outer surface of the inner pane is referred to as the interior surface of the inner pane, also called side IV, and adjoins the interior in the installed state.

The laminated pane is preferably a vehicle pane, i.e., it is suitable for installation in a vehicle, wherein the vehicle pane separates the vehicle interior from the vehicle environment in the installed state.

In one embodiment, the UV protection layer is formed from a UV-light-reflecting and/or UV-light-absorbing material.

In a preferred design, the UV protection layer comprises at least one layer of an optically high-refractive material, preferably having a refractive index of greater than or equal to 1.8, particularly preferably greater than or equal to 1.9, in particular greater than or equal to 2.

In a preferred embodiment, the UV protection layer is preferably an optically high-refractive layer, in particular having a refractive index greater than 1.8, which is designed as a coating, particularly preferably on the basis of silicon nitride, zinc tin oxide, silicon-zirconium nitride or titanium oxide (TiOx).

According to the invention, the optically high-refractive layer can be formed, for example, on the basis of titanium dioxide, silicon nitride, tin zinc oxide, silicon-zirconium nitride, silicon-titanium nitride, or silicon-hafnium nitride.

If a layer is formed on the basis of a material, the layer consists predominantly of this material, in particular substantially of this material, in addition to any impurities or doping. For example, the UV protection layer can be formed from the mentioned material to more than 95 wt. %, preferably more than 97 wt. %, for example 98 wt. % or more (of the UV protection layer).

These high-refractive layers can preferably be formed with a thickness of 10 nm to 100 nm, particularly preferably with a thickness of 20 nm to 50 nm.

In another design, the UV protection layer is multi-ply and comprises at least one layer of an optically high-refractive material and at least one layer of an optically low-refractive material.

In a further preferred embodiment, it is provided that the multi-ply UV protection layer comprises at least two layers (plies) of a high-refractive material, which are preferably separated from one another by a layer of optically low-refractive material.

According to the invention, the UV protection coating can be formed from alternately arranged layers with different refractive indices. The multi-ply UV protection coating preferably comprises at least two optically high-refractive layers, in particular having a refractive index greater than 1.8, and at least one optically low-refractive layer, in particular having a refractive index of less than 1.8, e.g., less than 1.6. Starting from the interior surface of the outer pane, first a first high-refractive layer, thereon a first low-refractive layer, thereon a second high-refractive layer are arranged on top of one another, preferably over the entire surface. Such an embodiment has proven to be particularly advantageous with regard to the UV protection effect of the coating. The high-refractive layers can be formed, for example, on the basis of silicon nitride, zinc tin oxide, silicon-zirconium nitride or titanium oxide; the low-refractive layers can be formed, for example, on the basis of silicon dioxide or magnesium fluoride. Both the materials of the optically high-refractive and also those of the low-refractive layers (plies) of the UV protection layer can be doped, for example with further transition metal oxides, such as ZnO, ZrO₂, HfOx.

In the context of the present invention, refractive indices are generally given relative to a wavelength of 550 nm. The refractive index can be determined, for example, by ellipsometry. Ellipsometers are commercially available-for example, from Sentech. The refractive index of a dielectric layer is preferably determined by first depositing it as a single layer on a substrate and subsequently measuring the refractive index by ellipsometry. Dielectric layers with the mentioned refractive indices and methods for their deposition are known to the person skilled in the art in the field of thin layers. Preferably, methods of physical vapor deposition, and in particular magnetron sputtering, or wet coating are used.

The optically low-refractive layers, for example made of silicon dioxide or magnesium fluoride, can preferably be formed with a thickness of 10 nm to 100 nm, particularly preferably with a thickness of 20 nm to 50 nm.

In an exemplary embodiment, the UV protection coating, starting from the interior surface of the outer pane, is formed as a three-ply UV protection layer from a 35 nm thick titanium dioxide layer, a 35 nm thick silicon dioxide layer arranged thereon, a 30 nm thick titanium dioxide layer arranged thereon.

In one embodiment of the invention, the single-ply or multi-ply UV protection layer is formed with a layer thickness of 10 nm to 200 nm, preferably of 20 nm to 100 nm, and particularly preferably of 30 nm to 80 nm.

In another design of the laminated pane according to the invention, the single-ply or multi-ply UV protection coating is formed from a UV-light-absorbing material or comprises such a material. Known examples suitable for the invention are organic layers, for example based on benzotriazole (e.g., commercially available under the trade name Tinuvin® from BASF), triazine or benzophenone or combinations thereof.

According to the invention, such organic UV protection layers are preferably formed with a thickness between 1 μm and 100 μm, for example with a thickness between 10 μm and 80 μm, for example with 20 μm, 40 μm, 50 μm or 60 μm.

The outer pane and the inner pane each have an exterior surface, i.e., an outer surface, and an interior surface, i.e., an inner surface, and a circumferential side edge extending therebetween. For the purposes of the invention, the term, “external surface,” refers to the main surface which, when installed, is intended to face the external surroundings. For the purposes of the invention, the term, “interior surface,” refers to the main surface which, when installed, is intended to face the interior. The interior surface of the outer pane and the exterior surface of the inner pane face one another in the laminated pane according to the invention.

The surfaces of the glass panes are typically referred to as follows:

The exterior surface of the outer pane is referred to as side I. The interior surface of the outer pane is referred to as side II. The exterior surface of the interior pane is referred to as side III. The interior surface of the inner pane is referred to as side IV.

If the laminated pane is provided in a window opening of a vehicle or of a building to separate an interior from the external environment, the term “inner pane,” for the purposes of the invention, refers to the pane facing the interior (vehicle interior). The outer pane refers to the pane facing the external surroundings.

The hologram element refers to the holographic medium in which the hologram is contained. The hologram element comprises a photosensitive material, i.e., a holographic material. A hologram can be recorded therein by exposure to a suitable light source. In the finished laminated pane, the material of the hologram element is no longer light-sensitive, because the holographic material is changed during the process to such an extent that no further recording of a hologram is possible.

The hologram element comprises a holographic material, and can additionally optionally comprise a first substrate layer and/or a second substrate layer. Suitable holographic materials are known to the person skilled in the art. Suitable first and second substrate layers are likewise known to the person skilled in the art.

Preferably, the hologram element comprises a photopolymer, dichromate gelatin, or silver halide gelatin, and particularly preferably a photopolymer, as the holographic material.

Silver halides or dichromates are typically used in a matrix of gelatin, which is first usually dried at room temperature before a hologram can be recorded by exposure to light.

In one embodiment, the holographic material is formed as a coating of the interior surface of the outer pane or as a coating of the outer surface of the inner pane.

The laminated pane can additionally comprise a second intermediate layer. In this embodiment of the laminated pane according to the invention, the hologram element is arranged between the first intermediate layer and the inner pane, and the additional second intermediate layer is arranged between the inner pane and the hologram element.

In a preferred embodiment, the hologram element comprises a holographic material, a first substrate layer, and a second substrate layer, wherein the holographic material is arranged between the first intermediate layer and the inner pane, a second intermediate layer is arranged between the holographic material and the inner pane, the first substrate layer is arranged between the holographic material and the first intermediate layer, and the second substrate layer is arranged between the holographic material and the second intermediate layer. The holographic material is consequently arranged in this embodiment between a first substrate layer and a second substrate layer.

In a further embodiment, the hologram element comprises a first substrate layer and a holographic material.

In this embodiment too, the laminated pane can optionally comprise a second intermediate layer. When a second intermediate layer is present, this is arranged between the inner pane and the hologram element, and the first intermediate layer is arranged between the outer pane and the hologram element.

The first intermediate layer is preferably a thermoplastic intermediate layer, an adhesive layer, or an optically clear adhesive (OCA).

The second intermediate layer is preferably a thermoplastic intermediate layer, an adhesive layer, or an optically clear adhesive (OCA).

An optically clear adhesive (OCA) is characterized by high light transmission, low turbidity, no double light refraction, high UV resistance, and good aging resistance. Uncontrolled and therefore undesirable impairment of light transmission or unaesthetic distortions can thus be avoided.

The adhesive layer preferably has an absorption in the visible spectral range of less than 5%, and in particular less than 2% or even 1%, and preferably a turbidity of less than 5%, and in particular less than 2% or even less than 1%.

The adhesive layer is preferably formed as a homogeneous layer.

The adhesive layer preferably has a thickness of 20 μm to 200 μm, particularly preferably of 50 μm to 150 μm, and very particularly preferably of 60 μm to 100 μm. Good optical properties are thus achieved. In addition, adhesive layers with these thicknesses are commercially available as adhesive films. Alternatively, the adhesive of the adhesive layer can also be used as a liquid adhesive.

The adhesive of the adhesive layer is preferably a chemically-active—in particular, chemically-curing—adhesive or UV-curing, and particularly preferably an acrylate adhesive or a silicone-based adhesive.

The first substrate layer contains, for example, polyamide (PA), cellulose triacetate (TAC), and/or polyethylene terephthalate (PET). The first substrate layer is, for example, 35 μm (micrometers) to 60 μm thick.

The second substrate layer contains, for example, polyamide (PA), cellulose triacetate (TAC), and/or polyethylene terephthalate (PET). The second substrate layer is, for example, 35 μm (micrometers) to 60 μm thick.

As described above, in a preferred embodiment, the holographic material comprises a photopolymer. The photopolymer is, for example, 10 μm to 100 μm, e.g., 16 μm, thick. Suitable photopolymers are known to the person skilled in the art. The photopolymer preferably comprises crosslinked polyurethane (PU). Alternatively, a liquid photopolymer can also be used.

The outer pane and the inner pane are made of glass, and particularly preferably soda-lime glass, as is customary for window panes. However, the outer pane and the inner pane can also be made of other types of glass, e.g., fused silica, borosilicate glass, or alumino-silicate glass, or of rigid clear plastics, e.g., polycarbonate or polymethyl methacrylate. The outer pane and inner pane can, independently of one another, be clear, or also tinted or colored. Laminated panes designed as windshields must have sufficient light transmission in the central viewing area—preferably at least 70% in the main viewing area A in accordance with ECE-R43. The outer pane and the inner pane are preferably bent, i.e., they have a curvature.

The outer pane and/or the inner pane can have further suitable coatings known per se, e.g., anti-reflective coatings, non-stick coatings, anti-scratch coatings, heatable coatings, sun protection coatings, or low-e coatings.

Preferably, a first intermediate layer or second intermediate layer formed as a thermoplastic intermediate layer contains or consists of at least polyvinyl butyral (PVB), ethylene vinyl acetate (EVA), polyurethane (PU), or copolymers or derivatives thereof, more preferably polyvinyl butyral (PVB), and most preferably polyvinyl butyral (PVB) and additives known to the person skilled in the art, such as plasticizers.

Preferably, a first intermediate layer or second intermediate layer formed as a thermoplastic intermediate layer contains at least 60 wt %, particularly preferably at least 70 wt %, in particular at least 90 wt %, and, for example, at least 97 wt %, polyvinyl butyral.

A first intermediate layer formed as a thermoplastic intermediate layer can be formed by a single film or also by more than one film.

A second intermediate layer formed as a thermoplastic intermediate layer can likewise be formed by a single film or also by more than one film.

The first intermediate layer and, if present, the second intermediate layer can also, independently of one another, be a functional intermediate layer, and in particular an intermediate layer with acoustic damping properties, an infrared radiation-reflecting intermediate layer, an infrared radiation-absorbing intermediate layer, a UV radiation-absorbing intermediate layer, an at least partially colored intermediate layer, and/or an at least partially tinted intermediate layer. Thus, the first intermediate layer and, if present, the second intermediate layer can, independently of one another, also be a bandpass filter film, for example. The mentioned embodiments of the intermediate layers are designed independently of other features of the laminated pane. Thus, an optionally present UV-radiation-absorbing function of the intermediate layer is in any case provided in addition to the UV protection layer of the outer pane but does not replace it.

The thickness of a first intermediate layer or second intermediate layer formed as a thermoplastic intermediate layer is between 30 μm and 1,500 μm, preferably between 50 μm and 780 μm, preferably 350 μm and 800 μm, for example 380 μm or 760 μm.

The hologram element preferably has a thickness of 5 μm to 500 μm, preferably of 10 μm to 200 μm, and particularly preferably of 15 μm to 150 μm.

The thickness of the outer pane and the inner pane can vary widely, and thus be adapted to the requirements in individual cases. The outer pane and the inner pane preferably have thicknesses of 0.5 mm to 5 mm, particularly preferably of 1 mm to 3 mm.

The laminated pane according to the invention can comprise one or more additional intermediate layers, and in particular functional intermediate layers. An additional intermediate layer can in particular be an intermediate layer with acoustic damping properties, an infrared radiation-reflecting intermediate layer, an infrared radiation-absorbing intermediate layer, an at least partially colored intermediate layer, and/or an at least partially tinted intermediate layer. When several additional intermediate layers are present, they can also have different functions.

A laminated pane according to the invention may additionally comprise a cover print—in particular of a dark, and preferably black, enamel. The cover print is in particular a peripheral, i.e., frame-like, cover print. The peripheral cover print primarily serves as UV protection for the mounting adhesive of the laminated pane. The cover print can be opaque and cover the entire area. The cover print can also be semi-transparent at least in sections, for example as a dot screen, striped screen or checkered screen. Alternatively, the cover print can also have a gradient—for example, from an opaque covering to a semi-transparent covering.

The hologram element preferably does not extend to the pane edge, while the first intermediate layer extends to the pane edge. In this embodiment, the hologram element in the laminated pane is sealed at its circumferential edge by the first intermediate layer or further layers arranged there, and thus protected from external influences such as moisture and cleaning agents.

Preferably, if the hologram element is not arranged over the entire area of the pane, a barrier film with a cutout is arranged in a frame-like manner around the hologram element. The cutout corresponds to the area in which the hologram element is arranged. The hologram element is arranged within this cutout and completely fills it. The barrier film is in the form of a circumferential frame and is in direct contact with the circumferential edge of the hologram element. The hologram element and the barrier film thus lie in the same plane and contact one another along their edges, wherein their contact faces are substantially orthogonal to the pane surfaces of the laminated pane. In the laminated pane according to the invention, the barrier film in the form of a circumferential frame compensates for a local difference in thickness between the area with the hologram element and the surrounding area. According to the invention, the barrier film does not overlap with the hologram element, but is merely applied in its immediate vicinity adjacent to the circumferential edge of the hologram element, thus enabling this compensation for differences in thickness. Accordingly, the laminated pane with a hologram element has not only improved aging resistance, but also improved durability due to minimization of stresses as well as glass breakage.

The barrier film is preferably a polymer layer and preferably contains or consists substantially of polyvinyl butyral (PVB), polyethylene terephthalate (PET), polyamide (PA), polyethylene (PE), polymethyl methacrylate (PMMA), polycarbonate (PC), polyvinyl chloride (PVC), cellulose triacetate (TAC).

The laminated pane according to the invention is preferably bent in one or more directions in space, as is customary for motor vehicle windows, wherein typical radii of curvature are in the range of about 10 cm to about 40 m. However, the laminated glass may also be planar—for example, if it is provided as a pane for buses, trains, or tractors.

A laminated pane according to the invention has a top edge and a bottom edge, as well as two side edges extending between the top edge and the bottom edge. The top edge refers to the edge which is intended to point upwards in the installed position. The bottom edge refers to the edge which is intended to point downwards in the installed position. The top edge is often also referred to as the roof edge and the bottom edge as the engine edge.

Laminated panes designed as windshields have a central field of view on whose optical quality high demands are placed. The central field of view must have high light transmission (typically greater than 70%). The said central field of view is in particular that field of view which is referred to by the person skilled in the art as field of view B, viewing range B, or zone B. The field of view B and its technical requirements are defined in Regulation No. 43 of the Economic Commission of the United Nations for Europe (UN/ECE) (ECE-R43, “Uniform provisions concerning the approval of safety glazing materials and their installation on vehicles”). The field of view B is defined therein in Appendix 18.

The hologram element is advantageously arranged within the central field of view (field of view B) in a laminated pane designed as a windshield. The hologram element can, but need not, cover the entire area, and can also project beyond it. The hologram element preferably extends over at least 30%, particularly preferably over at least 50%, further particularly preferably over at least 80%, of the pane. As a result, visible transitions between the hologram element and a section without hologram element in the visible area of the pane can be avoided. Particularly preferably, the hologram element is arranged such that the circumferential edge of the hologram element is arranged in the area of an opaque cover print. This has the advantage that the opaque cover print hides the transition from the hologram element to the surrounding layer. The cover print is usually located in the edge area of the pane and hides the view of mounting parts or adhesives. Windshields typically have a surrounding peripheral cover print made of an opaque enamel, which in particular serves to protect the adhesive used to install the windshield from UV radiation and to hide it visually. This peripheral cover print is preferably used to also cover the circumferential edge of the hologram element. Preferably, both the outer pane and the inner pane of the laminated pane have a cover print, such that visibility in the edge area is obstructed from both sides.

The hologram element can also have recesses or holes—for example, in the area of so-called sensor windows or camera windows. These areas are intended to be equipped with sensors or cameras whose function could be impaired by a hologram element in the beam path.

The hologram element is preferably arranged over the entire width and the entire height of the laminated pane, and particularly preferably minus a circumferential edge area with a width of, for example, 5 mm to 50 mm. The hologram element is thus protected from contact with the surrounding atmosphere and corrosion. The width of the circumferential edge area can be constant or vary.

The laminated pane can, for example, be the windshield or roof pane of a vehicle or another vehicle glazing, e.g., a separating pane in a vehicle, preferably in a rail vehicle or bus. Alternatively, the laminated pane can be an architectural glazing, for example in an outer façade of a building or a separating pane inside a building.

The invention also comprises a projection arrangement for presenting information to a viewer, at least comprising a laminated pane according to the invention and a projector which is directed from inside onto the hologram element. The laminated pane according to the invention can be formed as described above in the various embodiments.

The projector of the projection arrangement emits light with wavelengths to which the hologram, or, if there is more than one hologram, the holograms of the hologram element respond.

The invention also relates to a method for producing a laminated pane, wherein at least:
a) an outer pane having an outer surface and an interior surface, a UV protection layer being formed on the interior surface of the outer pane, a first intermediate layer, a hologram element having at least one hologram, and an inner pane having an outer surface and an interior surface are provided,
b) a layer stack is formed in which the first intermediate layer is arranged between the outer pane and the inner pane, and the hologram element is arranged between the outer pane and the first intermediate layer or between the inner pane and the first intermediate layer,
c) the layer stack is joined by lamination.

The hologram element can contain, for example, dichromate gelatin or silver halide gelatin or a photopolymer as the holographic material, as described above.

In the embodiment of the method according to the invention described above, the optically highly-refractive layer is applied to the interior surface of the inner pane before lamination.

The UV protection layer can, for example, be applied to the interior surface of the outer pane by methods established per se, such as wet coating, by magnetron sputtering or by chemical (CVD) or physical vapor deposition (PVD) methods.

Advantageously, such a coating can be incorporated into the industrial series production of laminated panes without difficulty and at low cost.

It is understood that in step a), instead of a hologram element in which at least one hologram is recorded, an unexposed hologram element precursor made of light-sensitive material can alternatively be provided in each case. Thus, the formation of the layer stack can also take place in step b), and the lamination with the unexposed hologram element precursor or with the final hologram element with recorded hologram element can take place in step c). It is understood that, when the unexposed hologram element precursor is provided in step a), a method according to the invention comprises recording at least one hologram in the hologram element precursor as an additional step after the lamination of the layer stack.

The layer stack is preferably laminated under the action of heat, vacuum, and/or pressure. Methods known per se for lamination can be used-for example, autoclave methods, vacuum bag methods, vacuum ring methods, calendering methods, vacuum laminators, or combinations thereof.

If the laminated pane is to be bent, the outer pane and the inner pane are preferably subjected to a bending process before lamination. Preferably, the outer pane and the inner pane are jointly bent congruently (i.e., at the same time and by the same tool), because this optimally matches the shape of the panes for the subsequent lamination. Typical temperatures for glass bending processes are, for example, 500° C. to 700° C.

Any opaque cover prints, i.e., in particular, circumferential black prints in the edge area of the pane, are preferably applied by screen printing.

The embodiments described above in connection with the laminated pane according to the invention also apply in the same way to the method according to the invention, and vice versa.

The invention furthermore comprises the use of a laminated pane according to the invention with at least one hologram as an inner glazing or outer glazing in a vehicle or building, in particular a vehicle pane in locomotion means for traffic on land, in the air, or on water, in particular in motor vehicles and in particular as a windshield serving as a projection surface for a head-up display.

The invention is explained in more detail with reference to drawings and exemplary embodiments. The drawings are schematic representations and are not true-to-scale. The drawings do not limit the invention in any way. In the drawings:

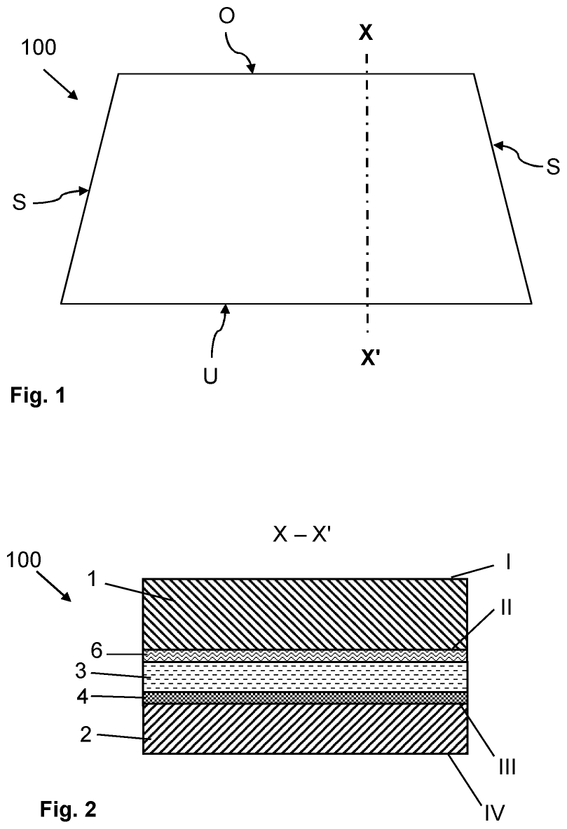

FIG. 1 shows a plan view of a design of a laminated pane 100 according to the invention,

FIG. 2 shows a cross-section through the design of a laminated pane 100 according to the invention shown in FIG. 1;

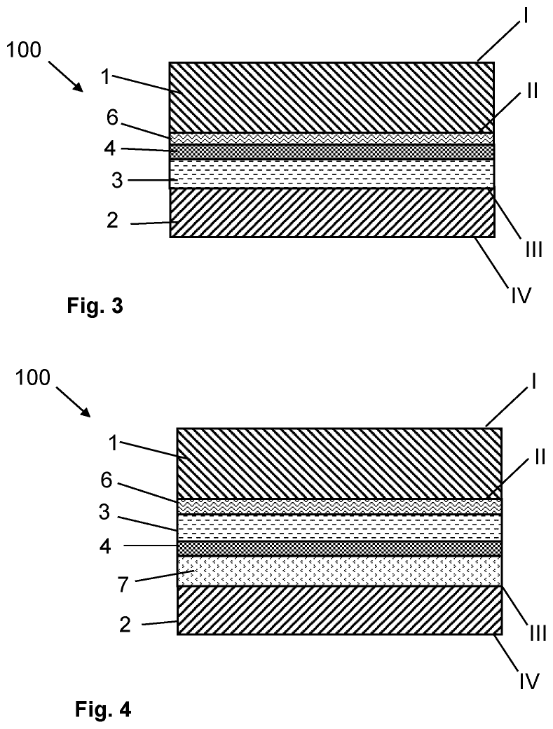

FIG. 3 shows a cross-section through a further design of a laminated pane 100 according to the invention,

FIG. 4 shows a cross-section through a further design of a laminated pane 100 according to the invention,

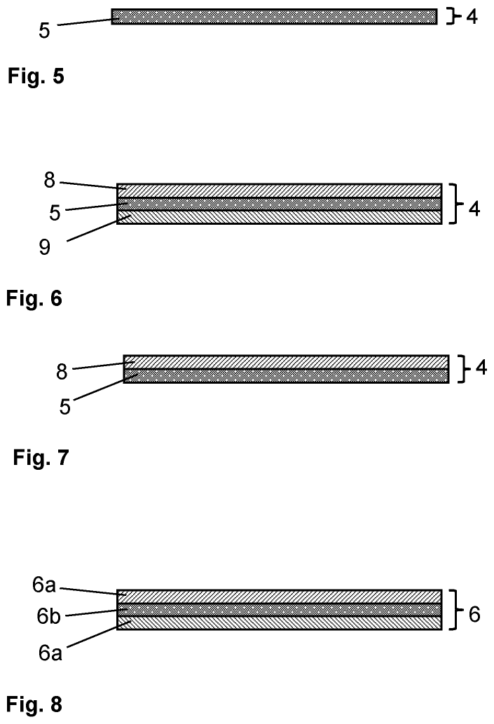

FIG. 5 shows a cross-section of an embodiment of a hologram element,

FIG. 6 shows a cross-section of a further embodiment of a hologram element,

FIG. 7 shows a cross-section of a further embodiment of a hologram element,

FIG. 8 shows a cross-section of an embodiment of a multi-ply UV protection layer according to the invention,

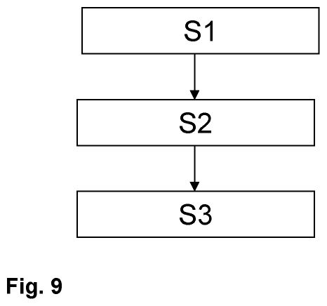

FIG. 9 shows an exemplary embodiment of a method according to the invention using a flowchart.

FIG. 1 shows a plan view of a design of a laminated pane 100 according to the invention, and FIG. 2 shows the cross-section through the design of a laminated pane 100 according to the invention shown in FIG. 1 along the line of intersection X-X′. In the embodiment shown in FIG. 1, the laminated pane 100 has a top edge O, a bottom edge U, and two side edges S. As illustrated in FIG. 2, the laminated pane 100 comprises an outer pane 1 having an outer surface I and an interior surface II, a first intermediate layer 3, a hologram element 4, an inner pane 2 having an outer surface III and an interior surface IV, and a UV protection layer 6, which is preferably applied as a coating over the entire area of the interior surface Il of the outer pane 1. Thus, the UV protection layer can filter or block harmful UV light from the incident sunlight and protect the hologram element. Aging processes induced by the UV light component in the incident sunlight, and thus changes in properties and appearance of the laminated pane 100 and in particular of the hologram element 4, can be avoided or at least delayed. The durability and service life of the laminated pane with the hologram element with consistently good quality of the holographic HUD function can thus be significantly increased.

In the embodiment shown in FIGS. 1 and 2, the hologram element 4 is arranged over the entire area between the outer pane 1 and the inner pane 2, the first intermediate layer 3 is arranged over the entire area between the outer pane 1 and the hologram element 4, and the UV coating 6 is applied as a coating over the entire area of the interior surface II of the outer pane 1.

The outer pane 1 consists, for example, of soda-lime glass and is 2.1 mm thick. The inner pane 2 consists, for example, of soda lime-glass and is 1.6 mm thick.

In the embodiment shown in FIGS. 1 and 2, the first intermediate layer 3 is, for example, a thermoplastic intermediate layer, consists, for example, of polyvinyl butyral (PVB), and is 0.76 mm thick.

In the embodiment shown in FIGS. 1 and 2, the hologram element 4 is formed, for example, as shown in FIG. 5 or 7. If the hologram element 4 is formed as illustrated in FIG. 7, the hologram element 4 is preferably arranged such that the first substrate layer 8 is arranged directly adjacent to the first intermediate layer 3.

FIG. 3 shows a cross-section of a further design of a laminated pane 100 according to the invention. The laminated pane 100 shown in cross-section in FIG. 3 differs from that shown in FIG. 2 only in that the first intermediate layer 3 is arranged between the inner pane 2 and the hologram element 4.

In the embodiment shown in FIG. 3, the hologram element 4 is formed, for example, as shown in FIG. 5 or 7. If the hologram element 4 is formed as illustrated in FIG. 7, the hologram element 4 is preferably arranged such that the first substrate layer 8 is arranged directly adjacent to the first intermediate layer 3.

FIG. 4 shows a cross-section of a further design of a laminated pane 100 according to the invention. The laminated pane 100 shown in cross-section in FIG. 4 differs from that shown in FIG. 2 in that a second intermediate layer 7 is arranged between the hologram element 4 and the inner pane 2. The second intermediate layer 7 is, for example, a thermoplastic intermediate layer and consists, for example, of polyvinyl butyral (PVB) and is 0.76 mm thick.

In the embodiment shown in FIG. 4, the hologram element 4 is formed, for example, as shown in FIG. 5, 6, or 7.

FIG. 5 shows a cross-section of an embodiment of a hologram element 4. In the embodiment shown in FIG. 5, the hologram element 4 consists of a holographic material 5. The holographic material 5 is, for example, a photopolymer, dichromate gelatin, or silver halide gelatin.

FIG. 6 shows a cross-section of a further embodiment of a hologram element 4. In the embodiment shown in FIG. 6, the hologram element 4 comprises a first substrate layer 8, a second substrate layer 9, and a holographic material 5 arranged in-between. The holographic material 5 is, for example, a photopolymer, dichromate gelatin, or silver halide gelatin.

FIG. 7 shows a cross-section of a further embodiment of a hologram element 4. In the embodiment shown in FIG. 7, the hologram element 4 comprises a first substrate layer 8 and a holographic material 5. The holographic material 5 is, for example, a photopolymer, dichromate gelatin, or silver halide gelatin.

FIG. 8 shows a cross-section of an embodiment of a multi-ply UV protection layer 6. In the embodiment shown in FIG. 8, the three-ply UV protection layer comprises a first and a second optically high-refractive layer 6a, and an optically low-refractive layer 6b arranged therebetween. The two optically high-refractive layers 6a can be formed independently of one another, for example from silicon nitride, zinc tin oxide, silicon-zirconium nitride or titanium oxide, titanium dioxide; the low-refractive layer 6b can be formed, for example, from silicon dioxide or magnesium fluoride. Both the materials of the optically high-refractive and also those of the low-refractive layers 6a, 6b (plies) of the UV protection layer 6 can be doped, for example with further transition metal oxides, such as ZnO, ZrO₂, HfOx. In an exemplary embodiment, the UV protection coating 6, starting from the interior surface of the outer pane II, is formed as a three-ply UV protection layer 6 from a 35 nm thick titanium dioxide layer, a 35 nm thick silicon dioxide layer arranged thereon, a 30 nm thick titanium dioxide layer arranged thereon.

The layers 6a and 6b of the UV protection layer 6 can preferably be formed with a thickness of 10 nm to 100 nm, particularly preferably with a thickness of 20 nm to 50 nm.

FIG. 9 shows an exemplary embodiment of the method according to the invention for producing a laminated pane 100 according to the invention using a flowchart, comprising the steps of:

S1 providing an outer pane 1 having an outer surface I and an interior surface II, a single-ply or multi-ply UV protection layer being applied to the interior surface II, a first intermediate layer 3, a hologram element 4 having at least one hologram, and an inner pane 2 having an outer surface Ill and an interior surface IV and an optically high-refractive layer 6 applied to the interior surface IV.

S2 forming a layer stack in which and the first intermediate layer 3 is arranged between the outer pane 1 and the inner pane 2, and the hologram element 4 is arranged between the outer pane 1 and the first intermediate layer 3 or between the inner pane 2 and the first intermediate layer 3.

S3 joining the layer stack by lamination.

### EXAMPLE

An outer pane according to the invention is produced with a three-ply UV protection layer on the interior surface II of the outer pane, the UV protection coating having the following structure starting from the side II: a TiO₂ layer with a thickness of 35 nm, an SiO₂ layer with a thickness of 35 nm and a TiO₂ layer with 30 nm.

An exactly identical outer pane for a laminated pane without the UV protection layer according to the invention is provided in order to carry out comparative measurements of light transmission (TL (A)) and UV light reflection (UV A and UV B blocking).

These outer panes are measured in a stack with a respectively identical inner pane for a laminated pane.

The results of these measurements carried out identically are reproduced in Table 1.

TABLE 1

| | TL (A) [%] | UV A [%] | UV B [%] |
|---|---|---|---|
| Comparative example without | 81.1 | 45.9 | 31.6 |
| UV protection layer | | | |
| with UV protection layer | 80.4 | 20.7 | 11.4 |
| according to the invention | | | |

The measured values obtained and the comparison thereof show that, when an outer pane according to the invention is measured, the transmission of visible light is advantageously only very slightly reduced in comparison to the pane stack without the UV protection layer according to the invention, while the light components both in the UV A and UV B spectrum can be significantly reflected (blocked) by the coating according to the invention on the side II of the outer pane. As a result of the efficient filtering according to the invention of the harmful UV light components from the incident sunlight, aging processes, in particular changes in the properties of the hologram element, can advantageously be avoided or significantly delayed. The durability and lifetime of a laminated pane according to the invention with constant quality of the holographic HUD function can thus be increased and prolonged.

### List of Reference Signs

100 Laminated pane
1 Outer pane
2 Inner pane
3 First intermediate layer
4 Hologram element
5 Holographic material
6 UV protection layer
6a Optically high-refractive UV protection layer
6b Optically low-refractive UV protection layer
7 Second intermediate layer
8 First substrate layer
9 Second substrate layer
I Outer surface of the outer pane 1
II Interior surface of the outer pane 1
III Outer surface of the inner pane 2
IV Interior surface of the inner pane 2
O Upper edge
U Lower edge
S Side edge
X-X Cutting line

1. A laminated pane, comprising:
an outer pane having an outer surface and an interior surface,
an inner pane having an outer surface and an interior surface,
a first intermediate layer, and
a hologram element having at least one hologram,
wherein the first intermediate layer is arranged between the outer pane and the inner pane, the hologram element is arranged between the outer pane and the first intermediate layer or between the inner pane and the first intermediate layer,
and wherein a single-ply or multi-ply UV protection layer in the form of a coating is applied to the interior surface of the outer pane at least in the region of the hologram element.

2. The laminated pane according to claim 1, wherein the UV protection layer is formed from a UV-light-reflecting and/or UV-light-absorbing material.

3. The laminated pane according to claim 1, wherein the UV protection layer has at least one layer of an optically high-refractive material having a refractive index of greater than or equal to 1.8.

4. The laminated pane according to claim 1, wherein the UV protection layer comprises at least one optically high-refractive layer having a refractive index of greater than or equal to 1.8, on the basis of titanium dioxide, silicon nitride, tin zinc oxide, silicon-zirconium nitride, silicon-titanium nitride, or silicon-hafnium nitride.

5. The laminated pane according to claim 1, wherein the UV protection layer has at least one optically low-refractive layer having a refractive index of less than 1.8.

6. The laminated pane according to claim 1, wherein the UV protection layer has at least one layer of an optically high-refractive material having a refractive index of greater than or equal to 1.8 and at least one layer of an optically low-refractive material having a refractive index of less than 1.8.

7. The laminated pane according to claim 1, wherein the single-ply or multi-ply UV protection layer is formed with a layer thickness of 10 nm to 200 nm.

8. The laminated pane according to claim 1, wherein the hologram element is arranged between the first intermediate layer and the inner pane, and the laminated pane additionally comprises a second intermediate layer which is arranged between the inner pane and the hologram element.

9. The laminated pane according to claim 1, wherein the first intermediate layer and/or, if present, the second intermediate layer is, independently of one another, a thermoplastic intermediate layer, an adhesive layer or an optically clear adhesive.

10. The laminated pane according to claim 1, wherein the hologram element comprises a holographic material and, optionally, a first substrate layer and/or a second substrate layer.

11. The laminated pane according to claim 1, wherein the hologram element comprises a photopolymer, dichromate gelatin, or silver halide gelatin as the holographic material.

12. A projection arrangement comprising a laminated pane according to claim 1 and a projector which is directed from an interior onto the hologram element, wherein the interior surface of the inner pane is the surface of the laminated pane closest to the projector.

13. A method for producing a laminated pane according to claim 1, comprising:
a) providing an outer pane having an outer surface and an interior surface, a UV protection layer being applied to the interior surface, a first intermediate layer, a hologram element having at least one hologram, and an inner pane having an outer surface and an interior surface,
b) forming a layer stack in which the first intermediate layer is arranged between the outer pane and the inner pane, and the hologram element is arranged between the outer pane and the first intermediate layer or between the inner pane and the first intermediate layer, and
c) joining the layer stack by lamination.

14. The method for producing a laminated pane according to claim 13, wherein the single-ply or multi-ply UV protection layer is applied to the interior surface of the outer pane by wet coating, by magnetron sputtering, or by chemical (CVD) or physical vapor deposition (PVD) methods.

15. A method comprising implementing a laminated pane according to claim 1 as an inner glazing or outer glazing in a vehicle or a building.

16. The laminated pane according to claim 5, wherein the at least one optically low-refractive layer is based on silicon dioxide or magnesium fluoride.

17. The laminated pane according to claim 6, wherein the UV protection layer has at least two layers of a high-refractive material.

18. The laminated pane according to claim 6, wherein optically high-refractive and optically low-refractive layers are arranged alternately flatly on top of one another.

19. The laminated pane according to claim 7, wherein the single-ply or multi-ply UV protection layer is formed with a layer thickness of 20 nm to 100 nm.

20. The method according to claim 15, wherein the laminated pane is a vehicle pane in a locomotion vehicle for traffic on land, in the air, or on water, that optionally serves as a projection surface for a head-up display.
